(19) United States
(12) Patent Application Publication
(10) Pub. No.: US 2011/0137540 A1
(43) Pub. Date: Jun. 9, 2011

(54) Internal Combustion Engine and Method for Operating an Internal Combustion Engine of Said Type

(75) Inventors: Wolfgang Mai, Kronberg (DE); Paul Rodatz, Landshut (DE); Rudolf Bierl, Regensburg (DE); Stephan Heinrich, Pfeffenhausen (DE); Manfred Weigl, Viehhausen (DE); Andreas Wildgen, Nittendorf (DE)

(73) Assignee: Continental Automotive GmbH, Hannover (DE)

(21) Appl. No.: 13/001,748

(22) PCT Filed: Jul. 13, 2009
(86) PCT No.: PCT/EP2009/058911

§ 371 Date: Feb. 22, 2011

(30) Foreign Application Priority Data
Jul. 14, 2008 (DE) 10 2008 033 058.2

(51) Int. Cl. F02D 41/00

(52) U.S. Cl. 701/103

(57) ABSTRACT

During the operation of an internal combustion engine which has at least one sensor for measuring a hydrocarbon content and a mass flow rate of a gas flow through a line, the hydrocarbon content and the mass flow rate of the gas flow are determined. The gas flow through the line is controlled as a function of the determined values.

### PRIORITY CLAIM

This is a U.S. national stage of Application No. PCT/EP2009/058911, filed on Jul. 13, 2009, which claims priority to German Application No: 10 2008 033 058.2, filed: Jul. 14, 2008, the contents of which are incorporated herein by reference.

### BACKGROUND OF THE INVENTION

1. Field of the Invention

The invention relates to an internal combustion engine and a method for operating an internal combustion engine.

2. Related Art

The fuel tank of a motor vehicle, in which gasoline may be stored, may emit gases that are released from the fuel. Under high outside temperatures or as a result of vibrations of the fuel tank during travel, highly volatile hydrocarbons may be released from the fuel, and leave the fuel tank as gas. To counteract this, fuel tanks may be sealed in a gastight manner. The volatile hydrocarbons are then temporarily stored in a reservoir and can be supplied to the intake air of the engine.

If it is not known, or not known sufficiently, how much of the hydrocarbons is absorbed in the intake air. It cannot be controlled accurately enough how much less fuel has to be injected to achieve a fuel/air ratio that is as optimum as possible. This leads to increased fuel consumption of the engine and possibly also to poorer exhaust gas values.

### SUMMARY OF THE INVENTION

It is an object of the invention to provide an internal combustion engine and a method for operating an internal combustion engine that operates with lower emissions and/or greater efficiency.

A method for operating an internal combustion engine system which has at least one sensor for measuring a hydrocarbon content of the gas flow in a line comprises determining the hydrocarbon content of the gas flow flowing through the line. The mass flow rate of the gas flow flowing through the line is determined. At least one actuating device for controlling the gas flow through a line is controlled dependent on the hydrocarbon content determined and the mass flow rate determined.

At least one signal of at least one semiconductor device integrated in the at least one sensor may be evaluated. The at least one sensor may have at least one temperature sensor. At least one signal of the at least one temperature sensor may be evaluated. At least one signal of at least one ultrasound receiver may also be evaluated. The hydrocarbon content and the mass flow rate can be concluded relatively easily from the signals.

At least one valve is arranged in the line and may be controlled dependent on the determined hydrocarbon content and mass flow rate. As a result, the at least one valve can be controlled relatively accurately how much energy in the form of gaseous hydrocarbons is directed to the engine by way of the intake air.

The fuel supply to an engine may be controlled dependent on the determined hydrocarbon content and mass flow rate. This allows the mixture of fuel and gaseous hydrocarbons of the intake air to be set as well as possible.

An internal combustion engine system comprises at least one sensor for measuring the hydrocarbon content of a gas flow in a line. The internal combustion engine system comprises an evaluating device for evaluating at least one signal of the at least one sensor. At least one actuating device for controlling the gas flow through the line is coupled to the evaluating device and can be controlled by the evaluating device in dependence on the signals evaluated.

The at least one sensor may have at least one heating element for heating a gas flow and at least one temperature sensor. The at least one sensor may have at least a first and a second temperature sensor, the at least one heating element being arranged between the first temperature sensor and the second temperature sensor. In this construction, the hydrocarbon content and the mass flow rate can be determined relatively accurately.

In a further embodiment, the at least one sensor may have at least one ultrasound source and at least one ultrasound receiver, which are arranged in the line. The at least one ultrasound source and the at least one ultrasound receiver may be formed as a single component. Thus, the hydrocarbon content and the mass flow rate can be determined as accurately as possible.

The actuating device may be arranged on the line. The actuating device may comprise a valve which can be clock-controlled in dependence on at least one signal of the evaluation unit. Thus, the control of the gas flow through the line can be realized relatively inexpensively and accurately.

The evaluation unit may be part of an engine control module for operating the internal combustion engine.

### BRIEF DESCRIPTION OF DRAWINGS

Further features, advantages, and developments are provided by the following examples that are explained in conjunction with FIGS. 1 to 4, in which:

FIG. 1 is a schematic representation of an internal combustion engine system;

FIG. 2 is a schematic representation of a sensor and a valve in a line;

FIG. 3 is a schematic representation of a sensor according to a further embodiment; and

FIG. 4 is a flow diagram of a method.

### DETAILED DESCRIPTION OF THE DRAWINGS

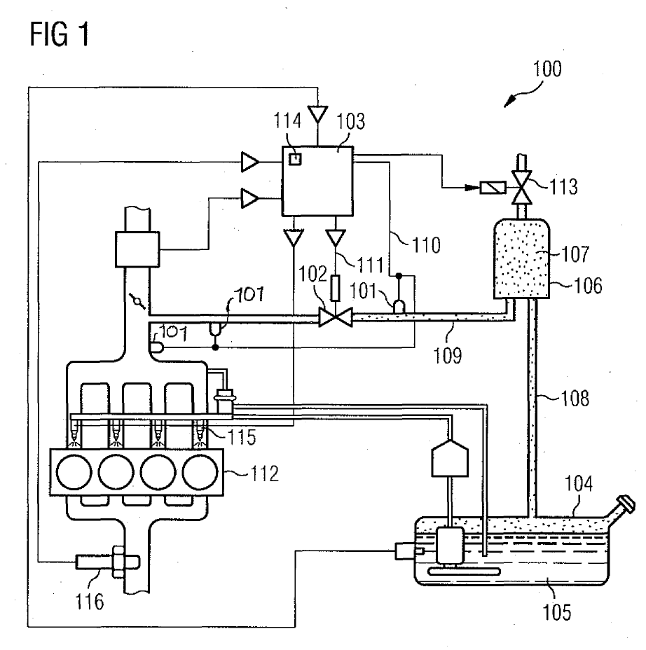

FIG. 1 is an internal combustion engine system 100, which has a fuel tank 104, an engine 112 and a hydrocarbon tank 106. In the fuel tank 104, fuel 105 is stored. Gaseous hydrocarbons 107 can be directed out of the fuel tank 104 into the hydrocarbon tank 106 by way of a line 108, which is coupled to the fuel tank 104 and the hydrocarbon tank 106. The hydrocarbon tank 106 is coupled by way of a line 109 to the engine 112, in particular the intake tract of the engine 112.

The line 109 has a valve 102 as well as a plurality of hydrocarbon sensors 101. The hydrocarbon sensors 101 are designed to measure the hydrocarbon content of a gas flow. The hydrocarbon sensors 101 may also measure the mass flow rate of the hydrocarbons in the gas flow. There may also be only one hydrocarbon sensor 101, or else further hydrocarbon sensors 101, for example on the hydrocarbon tank 106. The hydrocarbon sensors 101 may also be arranged on further lines, for example on the line 108. The valve 102 is designed to interrupt the gas flow to the engine 112. The gas flow through the line 109 may be controlled by the valve 102. A number of valves may also be arranged, for example two or more valves. Valves may also be arranged on further lines, for example on the line 108.

The valve 102 is coupled by way of an electrical line 111 to a motor control module 103. The sensors 101 are coupled by way of an electrical line 110 to the motor control module 103. The motor control module 103, which has an evaluating device 114, controls the valves 102, 113 and can evaluate signals of the sensors 101.

The fuel 105 can be conducted by a fuel feed unit by way of fuel lines to the engine 112, where it is injected by way of injection valves 115 into the intake tract and is combusted in the engine 112. The exhaust gases of the combustion process are carried away from the engine through an exhaust line. Arranged in the exhaust line is a lambda probe 116, which can determine a ratio of air to fuel. For this purpose, the lambda probe 116 measures the residual oxygen content in the exhaust gas.

From the fuel 105, for example gasoline, hydrocarbons evaporate, for example methane, butane or propane. The various hydrocarbon chains have different evaporating temperatures, so that, dependent on the outside temperature, different hydrocarbons are released by the liquid fuel 105. The higher the outside temperature, and consequently the temperature of the fuel 105, the more hydrocarbons go over into the gas phase. The tank 104, in which the fuel 105 is stored, is of a gastight configuration. The tank cover seals a filling nozzle of the fuel tank in a gastight manner. The hydrocarbon-containing gas mixture that forms in the tank 104 is conducted into the hydrocarbon tank 106 by way of the line 108.

The hydrocarbon tank 106 may contain an activated carbon storage element. The evaporated hydrocarbons are taken up by the activated carbon, stored and given off again when required. When the hydrocarbon tank 106 has taken up a certain amount of hydrocarbons, it can be emptied by way of the line 109. For this purpose, air is blown into the hydrocarbon tank from the outside by way of a valve 113 and the blown air takes up the hydrocarbons. The hydrocarbon-containing air can be used as intake air for the engine 112, and in this way contribute to the combustion in the engine 112.

Since a certain amount of energy is supplied to the engine 112 through the hydrocarbons in the intake air, correspondingly less fuel can be injected by way of the injection valves 115. To regulate this ratio, the hydrocarbon content of the air supplied and the mass flow rate through the line 109 are measured by the hydrocarbon sensors 101.

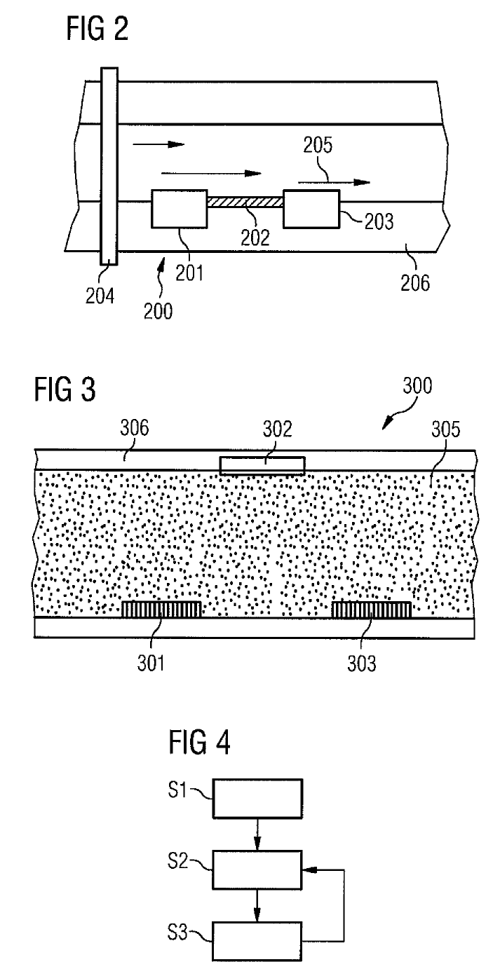

The sensors 101 shown in detail in FIG. 2 for measuring a hydrocarbon content have, for example, a heating element for heating up a gas flow and a temperature sensor. The sensor is integrated on a silicon chip. The gas flow flowing past the sensor element is heated up and the thermal conductivity or the thermal capacity of the gas flowing past can be determined on the basis of signals of the temperature sensor, which are evaluated by the engine control module 103, in particular the evaluation unit 114. From this, the concentration of the hydrocarbon in the gas flow can be determined, since it is proportional to the thermal conductivity or thermal capacity of the gas. The mass flow rate of the gas flow flowing through the line can also be determined.

The hydrocarbon sensor 101 may also have at least one ultrasound source and at least one ultrasound receiver as shown in FIG. 3. These sensors are arranged in the line 109 in such a way that ultrasound can be sent through the gas flow and passes from the ultrasound source to the ultrasound receiver. Ultrasound may be emitted on the one hand in a direction opposite to the direction of the gas flow and on the other hand in the same direction as the direction of the gas flow. From this, a velocity of the sound passing through the gas mixture and the velocity of the medium can be concluded. From this, the hydrocarbon content and the mass flow rate of the gas flow can be concluded. The at least one ultrasound source 301 and the at least one ultrasound receiver 303 may also be configured as a single component. Such an ultrasonic transducer is designed to generate ultrasonic waves in response to electrical signals. It is also designed to generate electrical signals from ultrasonic waves received. The ultrasonic transducer can convert electrical signals into acoustic signals and it can convert acoustic signals into electrical signals.

The evaluation unit 114 evaluates the signals of the sensors 101, so that the concentration of hydrocarbons and the mass flow rate of the gas flow through the line 109 are known. In this way it is known how much energy in the form of gaseous hydrocarbons is supplied to the engine 112. The engine control module 103 controls the injection valves 115 correspondingly, so that less fuel is injected when more hydrocarbon is supplied by way of the intake air. The amount of gaseous hydrocarbon can be controlled by way of the valve 102. The valve 102 is controlled by the engine control module 103, for example by way of pulse-width-modulated signals. The valve 102 may be clock-controllable in dependence on at least one signal of the evaluation unit 114. It can be determined by the sensors arranged downstream of the valve 102 in the direction of flow of the gas flow how much in the way of gaseous hydrocarbons passes through the valve 102. From this, the exact opening time of the valve 102 can also be determined. The activated carbon filter 106 can be emptied relatively quickly, since the control operates relatively quickly, in particular in comparison with a control based on data of the lambda probe 116.

The amount of fuel that is injected into the engine 112 by way of the injection valves 115 is not controlled on the basis of static characteristic maps which are stored in the engine control module 103, but is determined directly by the sensors 101 and the evaluating device 114. The valve 102 is activated on the basis of these data. Thus, production tolerances and aging effects of the valve can also be taken into consideration in the control of the valve and the control of other components, for example the injection valves 115.

FIG. 2 shows a sensor 200 and a valve 204, which are arranged in a line 206. In the line 206, a gas 205 is conducted. The sensor 200 has a temperature sensor 201 and a further temperature sensor 203, which are respectively arranged on one side of a heating element 202. The sensor 200 is designed to measure the concentration of hydrocarbon in the gas 205. The sensor 200 is further designed to measure the mass flow rate of hydrocarbon in the gas 205 through the line 206. The gas flow through the line 206 can be controlled by the valve 204. The sensor 200 may be coupled to an evaluating device 114, which is, for example, part of an engine control module 103 for operating an internal combustion engine 112.

The sensor 200 is, for example, integrated on a silicon substrate and may comprise further elements, for example an evaluation circuit or an analog-digital converter. The temperature sensor 201 and the temperature sensor 203 may respectively have a number of temperature sensors for measuring a temperature. The gas 205 flowing past the sensor 200 is heated in a defined manner by the heating element 202. The temperature sensor 201, which is arranged upstream of the heating element, senses the temperature of the gas flow before the gas flow is heated up. The further temperature sensor 203, which is arranged downstream of the heating element 202, senses the temperature of the heated gas. The thermal capacity of the gas can be concluded from a difference between these temperatures. From the sum of these temperatures, the thermal conductivity of the gas can be concluded. From this, the content of hydrocarbons in the gas 205 and the mass flow rate through the line 206 can be calculated.

Dependent on this data, the valve 204 can be controlled. The valve 204 may be coupled to an engine control module 103 for operating an internal combustion engine 112, in particular the evaluating device 114 of the engine control module 103. The valve 204 is controlled in dependence on the hydrocarbon concentration determined and the mass of hydrocarbons in the gas flow determined by the sensor 200. For example, the valve is controlled by way of a pulse-width-modulated signal. The valve 204 may be a clocked valve, which is clocked for example with a frequency of 20 Hz. The sensor 200 can be used to determine very accurately when hydrocarbons flow through the line 206 and how much. The sensor 200 allows very accurate determination of when and how far the valve 204 is opened. By using the data of the sensor 200, the engine control module 103 or the evaluating device 114 can measure as exactly as possible the amount of energy that is provided by the gas flow. This information can in turn be used for controlling the valve 204 and for controlling injection valves of the internal combustion engine 112 to control the ratio of fuel to gas as optimally as possible.

FIG. 3 shows a further configuration of a hydrocarbon sensor 300. The sensor 300 has an ultrasound source 301, which may likewise serve as an ultrasound receiver. The sensor has a further ultrasound source 303, which may likewise serve as an ultrasound receiver. The ultrasound sources 301 and 303 are arranged at a defined distance from each other in a line 306. Hydrocarbon-containing gas 305 flows through the line 306. Arranged on the line is an ultrasound reflector 302. The ultrasound sources 301, 303 and receivers 301, 303 may also be arranged lying opposite, so that no sound reflector 302 is necessary.

The ultrasound source 301 emits an ultrasonic pulse, which is sent by way of the ultrasound reflector 302 to the further ultrasound receiver 303. The transit time required for this may be measured by an evaluating device. Once the ultrasonic pulse has passed from the first ultrasound source 301 by way of the ultrasound reflector 302 to the further ultrasound receiver 303, the further ultrasound receiver is used as an ultrasound source. The ultrasound source 303 emits an ultrasonic pulse, which passes in a direction counter to the gas flow by way of the ultrasound reflector 302 to the first sound receiver 301. The transit time required for this is measured by the evaluating device.

From the measured transit times between the ultrasound sources and ultrasound receivers 301, 303, the velocity of the sound passing through the gas mixture 305 and the velocity with which the gas mixture flows through the line can be determined. For this purpose, a transit time total and a transit time difference may be formed. At least one valve may be controlled in dependence on the data determined, and the gas flow through the line 306 thereby controlled. At least one injection valve of an engine 112 may also be controlled in dependence on this data. An exact ratio of fuel to gas in the combustion chambers of the engine 112 can be set by using the data determined.

As shown in FIG. 4, in a first step S1 of a method for operating an internal combustion engine as shown in FIG. 4, the start takes place, and this may occur at a time close to that of the starting of the internal combustion engine 112. In a second step S2, the hydrocarbon content of a gas flow flowing through a line is determined. In step S2, the mass flow rate of the gas flow flowing through the line is also determined. In a third step S3, at least one actuating device is controlled dependent on the hydrocarbon content determined and the mass flow rate determined. The actuating device may comprise a valve which is clock-controllable in dependence on a pulse-width-modulated signal of an evaluating device. In step S3, a valve may be controlled, so that how much gaseous hydrocarbon is supplied to the internal combustion engine can be controlled. In step S3, the fuel supply to the engine can be controlled. The controlling of the fuel supply is dependent on the hydrocarbon content determined and the mass flow rate determined. Between step S2 and step S3 there is a constant feedback. The valve may be controlled dependent on the evaluated signal of the sensor. The sensor may check the control of the valve by measuring the hydrocarbon content and the mass flow rate of the gas flow downstream of the valve. This allows the functional capability of the valve to be monitored by comparing the measured data with stored scheduled data.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A method for operating an internal combustion engine, comprising at least one sensor configured to measure a hydrocarbon content of a gas flow in a line, the method comprising:
determining a mass flow rate of the gas flow flowing through the line;
controlling at least one actuating device configured to control the gas flow through the line, based at least in part on the determined hydrocarbon content and the determined mass flow rate;
evaluating at least one of:
at least one signal of at least one temperature sensor of the at least one sensor and
at least one signal of at least one ultrasound receiver;
determining the hydrocarbon content and the mass flow rate from the at least one of the at least one signal of the at least one temperature sensor and the at least one signal of the at least one ultrasound receiver.

12. The method as claimed in claim 11, further comprising:
evaluating at least one signal of at least one semiconductor device integrated in the at least one sensor.

13. The method as claimed in claim 11, further comprising:
controlling at least one valve which arranged on the line based at least in part on the determined hydrocarbon content and the determined mass flow rate.

14. The method as claimed in claim 11, further comprising:
controlling a fuel supply to the engine, based at least in part on the determined hydrocarbon content and the determined mass flow rate.

15. An internal combustion engine system, comprising:
at least one sensor configured to measure a hydrocarbon content of a gas flow in a line, the at least one sensor comprising at least one of:
at least one heating element for heating the gas flow and at least one temperature sensor configured to determine the hydrocarbon content and the mass flow rate, and
at least one ultrasound source and at least one ultrasound receiver arranged on the line, the at least one sensor configured to determine the hydrocarbon content and the mass flow rate;
an evaluating device configured to evaluate at least one signal of the at least one sensor; and
at least one actuating device coupled to the evaluating device for control by the evaluating device based at least in part on the evaluated signals and configured to control the gas flow through the line.

16. The internal combustion engine system as claimed in claim 15, wherein the at least one sensor comprises at least a first and a second temperature sensor, the at least one heating element being arranged between the first temperature sensor and the second temperature sensor.

17. The internal combustion engine system as claimed in claim 15, wherein the at least one ultrasound source and the at least one ultrasound receiver are formed as a single component.

18. The internal combustion engine system as claimed in claim 15, wherein the actuating device is arranged on the line.

19. The internal combustion engine system as claimed in claim 15, wherein the actuating device comprises a clock-controlled valve controlled based at least in part on at least one signal of the evaluation unit.

20. The internal combustion engine system as claimed in claim 15, wherein the evaluation unit is part of an engine control module configured to operate the internal combustion engine.

21. The method as claimed in claim 13, further comprising:
controlling a fuel supply to the engine, based at least in part on the determined hydrocarbon content and the determined mass flow rate.

22. The internal combustion engine system as claimed in claim 17, wherein the actuating device is arranged on the line.

23. The internal combustion engine system as claimed in claim 18, wherein the actuating device comprises a clock-controlled valve controlled based at least in part on at least one signal of the evaluation unit.

24. The internal combustion engine system as claimed in claim 19, wherein the evaluation unit is part of an engine control module configured to operate the internal combustion engine.
